(19) United States
(12) Patent Application Publication
(10) Pub. No.: US 2025/0164301 A1
(43) Pub. Date: May 22, 2025

(54) MEDICAL CARTRIDGE DISPENSERS, AND RELATED METHODS OF USE

(71) Applicant: 1360625 B.C. Ltd., Vernon (CA)

(72) Inventors: Anthony Berdan, Vernon (CA); Robert Colgan, Toronto (CA); Navdeep Singh, Toronto (CA); Harsimranjit Kaur, Toronto (CA)

(21) Appl. No.: 18/927,643

(22) Filed: Oct. 25, 2024

(30) Foreign Application Priority Data
Oct. 25, 2023 (CA) 3217691

(51) Int. Cl. G01F 11/28

(52) U.S. Cl. CPC G01F 11/284

(57) ABSTRACT

A medical cartridge dispenser has a storage container structured to retain a plurality of medical cartridges in use; a cartridge singulator; and a user proximity sensor connected to trigger the cartridge singulator to dispense a medical cartridge from an outlet of the storage container. In one method the presence of a user's hand is sensed in an activation zone adjacent a medical cartridge dispenser. A cartridge singulator is triggered to advance a single medical cartridge, from a plurality of medical cartridges retained within a storage container, through an outlet.

### TECHNICAL FIELD

This document relates to medical cartridge dispensers, and related methods of use.

### BACKGROUND

The following paragraph is not an admission that anything discussed in them is prior art or part of the knowledge of persons skilled in the art.

A cartridge warmer and dispenser made by Premier™ incorporates a heated storage container for plural carpules, which can be dispensed one at a time by depressing a lever.

### SUMMARY

A medical cartridge dispenser is disclosed comprising: a storage container structured to retain a plurality of medical cartridges in use; a cartridge singulator; and a user proximity sensor connected to trigger the cartridge singulator to dispense a medical cartridge from an outlet of the storage container.

A method is disclosed comprising: sensing the presence of a user's hand in an activation zone adjacent a medical cartridge dispenser; and triggering a cartridge singulator to advance a single medical cartridge, from a plurality of medical cartridges retained within a storage container, through an outlet.

In various embodiments, there may be included any one or more of the following features: The medical cartridge dispenser comprises a cartridge heater. The cartridge heater is structured to maintain medical cartridges in the storage container at body temperature. The cartridge heater comprises a resistive heating pad. The resistive heating pad underlies, overlies, or defines at least part of a cartridge exit chute upstream of or at the outlet in the storage compartment. The medical cartridge dispenser has a temperature sensor. The medical cartridge dispenser has a temperature controller connected in a feedback loop to control an internal temperature of the storage compartment using the heater. The cartridge singulator comprises a rotatable cam. The rotatable cam defines a cartridge-advancing part and an upstream-cartridge-blocking part. The cartridge singulator comprises a dispensing drum that defines the rotatable cam. The dispensing drum defines the rotatable cam in an axial direction along a cylindrical sidewall of the dispensing drum. The rotatable cam is formed as an axial slot in the cylindrical sidewall, with the cartridge-advancing part defined by the axial slot, and the upstream-cartridge-blocking part defined by the cylindrical sidewall. The dispensing drum is structured to perform a single rotation to dispense a single cartridge in use. The outlet is defined on a cartridge exit chute, and the cartridge singulator is structured to roll individual cartridges along the cartridge exit chute and out the outlet. The dispensing drum is oriented such that a rotational axis of the dispensing drum is parallel with a rolling axis of a cartridge seated in the dispensing drum during use. The cartridge singulator comprises a motor and a timing cam. The timing cam is structured to engage a limit switch during each action of dispensing a medical cartridge by the singulator. The storage container defines an internal medical-cartridge-stacking track. The internal medical-cartridge-stacking track comprises a serpentine chute. A cartridge catch is defined downstream of the outlet. The cartridge catch is formed of one or more cartridge stop walls that are adjacent a finger-receiving pincer zone. The user proximity sensor is configured to trigger the cartridge singulator upon detection of a user's hand above the cartridge catch. A plurality of carpules is retained as medical cartridges within the storage container. Initiating the user proximity sensor of the medical cartridge dispenser of claim 22 to trigger the cartridge singulator to dispense a medical cartridge from the outlet. Pre-heating the plurality of medical cartridges within the medical cartridge dispenser. Triggering further comprises rotating a dispensing drum, of the cartridge singulator, to engage, within an axial slot defined along the dispensing drum, a cylindrical sidewall of the single medical cartridge, and advance the single medical cartridge through the outlet.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a left isometric view of a medical cartridge dispenser.

FIG. 2 is a right isometric view of the medical cartridge dispenser of FIG. 1.

FIG. 3 is a top plan view of the medical cartridge dispenser of FIG. 1.

FIG. 4 is a bottom plan view of the medical cartridge dispenser of FIG. 1.

FIG. 5 is a rear elevation view of the medical cartridge dispenser of FIG. 1.

FIG. 6 is a front elevation view of the medical cartridge dispenser of FIG. 1.

FIG. 7 is an enlarged front elevation view of a medical cartridge.

FIG. 8 is a side elevation view of the medical cartridge dispenser of FIG. 1.

FIG. 9 is a top plan view of a proximity sensor used in the medical cartridge dispenser of FIG. 1.

FIG. 10 is a side elevation section view taken along the 10-10 section lines of FIG. 3.

FIG. 11 is a perspective view taken along the 10-10 section lines of FIG. 3.

FIG. 12 is a perspective view of a cartridge singulator and exit chute assembly of the medical cartridge dispenser of FIG. 1.

FIGS. 13-15 are a series of side elevation views, in partial section, illustrating a method of using the cartridge singulator of FIG. 12 to dispense a single medical cartridge and reload after dispensing.

FIG. 16 is an exploded perspective view of internal components of the medical cartridge dispenser of FIG. 1.

### DETAILED DESCRIPTION

Immaterial modifications may be made to the embodiments described here without departing from what is covered by the claims.

In dentistry, medicine, or biological research, cartridges—such as vials, ampoules, capsules, or carpules—may be used to store, protect and dispense medicines, anaesthetics, vaccines, injectable drugs, or sterile solutions. Cartridges may be small (for example, <50 cm³ although other sizes may be used), hermetically sealed containers, often tubular, that may protect their contents from degradation or loss due to the effects of temperature, inorganic or organic contamination, ultraviolet light, chemicals, evaporation, or oxygenation. Cartridges may be used to store biological samples such as blood, urine, saliva, or tissue samples. Cartridges may be made from glass, which has excellent chemical resistance and is highly inert, and may be sealed with a rubber stopper, plunger, or aluminum cap. Plastics such as polyethylene, polypropylene, and cyclic olefin copolymer may be used as cartridge materials, which may permit lighter, tougher cartridges. Cartridges, especially glass ones, may be siliconized or coated to reduce the interaction between the container and the medication—this may help prevent the adsorption of the contents onto the container's surface. Empty cartridges may be pre-sterilized, typically through processes like gamma irradiation or autoclaving, to ensure that they are free from contaminants before use.

Referring to FIG. 7, a cartridge 96, such as a carpule as illustrated, includes a type of cartridge used in medicine or dentistry to dispense a small, precise amount of a medicine or compound, for example an anaesthetic such as lidocaine or articaine. A carpule may comprise a cylindrical, hollow vial body 102 (made from glass, for example) sized for a particular application with a suitable outer diameter 110 and axial length 108. A carpule may be structured to operate as part of a syringe, and may thus comprise a sliding plug 98 and a penetrable lid 104. The carpule may be internally sterile and hermetically sealed prior to use. If the penetrable lid 104 is pierced, a payload 106 may be displaced from inside the cartridge 96 by shifting sliding plug 98 in an axial direction along an inner bore of cartridge 96. The sliding plug 98 may be equipped with a sealing lip 100 that maintains an airtight seal while the sliding plug 98 is shifted. A carpule may be configured to be disposable, i.e., discardable after a single use to prevent contamination. The use of a carpule may minimize patient discomfort because a carpule can be designed to administer a very precise dose of a medication. Carpules, and other cartridges, may be colour-coded for ease of use by dental or medical staff. In addition to anaesthetic, carpules may be used, for example, to dispense small quantities of dental filling compounds, such as composite resins consisting of mixtures of plastic resins and finely ground glass particles.

Referring again to FIG. 7, a carpule can be used in conjunction with a particular type of syringe. The carpule may then be inserted into the syringe (not shown), which has a barrel, plunger and needle. The syringe may be equipped with thumb and finger loops or other grips to facilitate operation of the plunger and loading of the barrel. After the carpule is loaded in the barrel and locked in place, the plunger may be depressed, contacting the sliding plug 98 and pressing the penetrable lid 104 against a perforator in the needle end of the inside of the barrel, acting to puncture the lid 104. Further movement by the plunger may act to engage a harpoon in the plunger with the plug 98, creating a connection between the two that permits the plunger to both pull and push the plug 98 as desired. Once the carpule is engaged by the plunger and perforated, further depressing of the plunger will act to displace the payload 106 of the cartridge 96 through the needle and into an injection site, for example a patient's gum tissue. The dentist may slowly administer the contents of the cartridge 96 and monitor the patient response. As above, some carpule and syringe systems allow aspiration, which is the application of a slight vacuum through the administration needle, after the tissue is pierced but before the carpule payload 106 is injected. This aspiration may allow the syringe user to verify that the needle tip has not penetrated a blood vessel. In the context of anaesthetic injection, the penetration of a blood vessel may be undesirable as such may lead to unintended transport of the anaesthetic throughout the body, leading to less effective pain relief at the site of the procedure than if the anaesthetic is administered into general tissue.

Anaesthetics are pharmacological agents employed to induce a temporary loss of sensation, such as pain-sensitivity, or in some cases, consciousness, in patients, primarily for the purpose of facilitating medical procedures and minimizing pain. Anaesthetics may be general, regional or local, and may be administered by various methods, such as inhalation, intravenous injection (in the case of general anaesthetics), or direction injection into relevant tissues, such as injection into the spinal canal or into the gums of a patient.

In dentistry or oral surgery, local anaesthetics may commonly be used for procedures such as tooth extractions, larger dental fillings, root canals (i.e., the removal of damaged or infected pulp from the inside of a tooth), scaling or root planing, dental implant placement, wisdom tooth extraction, orthognathic surgery, and jaw surgery. Common anaesthetics that are usually injected directly into the gum tissue include lidocaine, articaine, mepivacaine, and bupivacaine. For milder pain management, topical anaesthetics such as benzocaine or tetracaine may be applied to the surface of the gum or mucous membranes in the form of a gel, cream or spray. Vasoconstrictors, such as epinephrine, are often added to local anaesthetics to prolong their effectiveness by constricting blood vessels at the injection site. This helps reduce the rate at which the anaesthetic is metabolized and can extend the duration of numbness. Lidocaine, for example, works by blocking nerve signals, and is chemically termed 2-(diethylamino)-N-(2,6-dimethylphenyl) acetamide. For dental anaesthetics administered by injection into the gum tissue, patient comfort may be maximized if the liquid anaesthetic is delivered when near the body temperature of the patient (approximately 37° C.).

To prevent patient infection in dental surgery, dentists and oral surgeons follow strict hygiene protocols. Dental surgical implements must be sterilized before use by, for example, autoclaving, chemical disinfection, or by using pre-sterilized disposable instruments. The dentist may administer or require the patient to use an antibacterial oral rinse before the beginning of a surgery. Dental workers may also use personal protective equipment (PPE) such as sterile gloves and masks to handle implements and administer surgical procedures. Protective gloves may be made from suitable materials, such as latex (a naturally derived rubber) or nitrile butadiene rubber (NBR). Such gloves are flexible and offer good tactile sensitivity for procedures where fine motor skills are needed. To maintain sterility, proper techniques are required when donning and doffing gloves, as well as in deciding when to replace contaminated gloves with new ones. For example, a medical professional may use a specific technique to avoid contacting one wrist with the fingers of the opposing hand when donning gloves. Once gloves are donned, only sterile surfaces can be handled without compromising the sterility of the gloved hands. If a non-sterile surface or object is contacted, gloves must be doffed and replaced, prolonging the surgical procedure and adding incremental risk to the health and comfort of a patient.

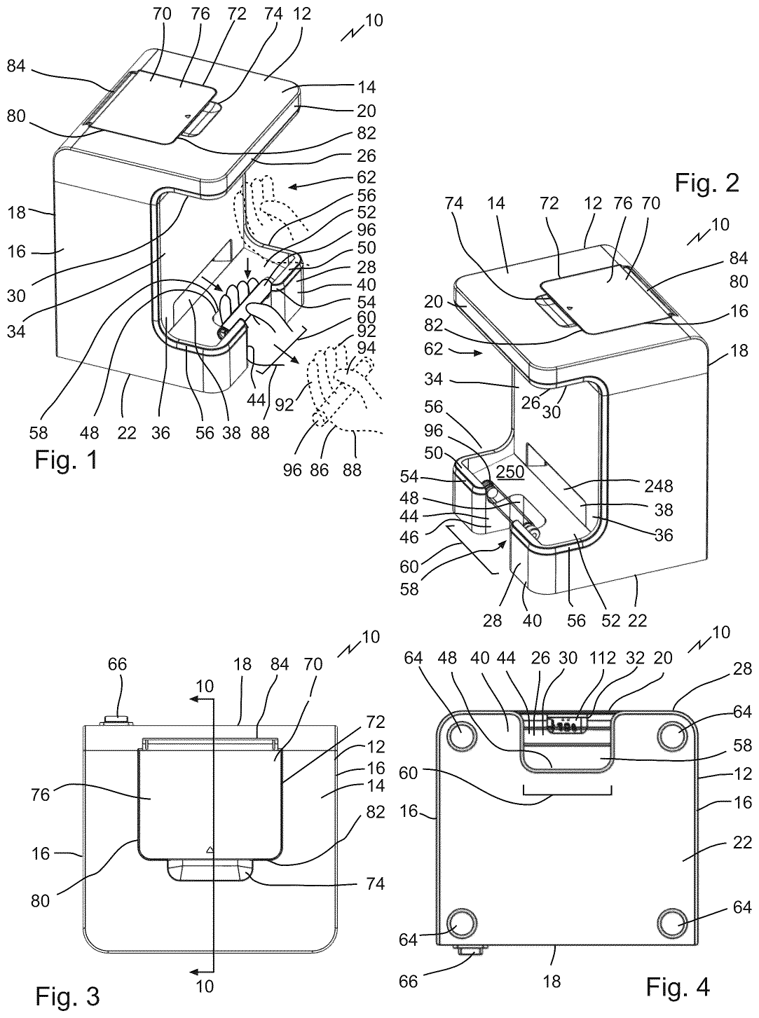

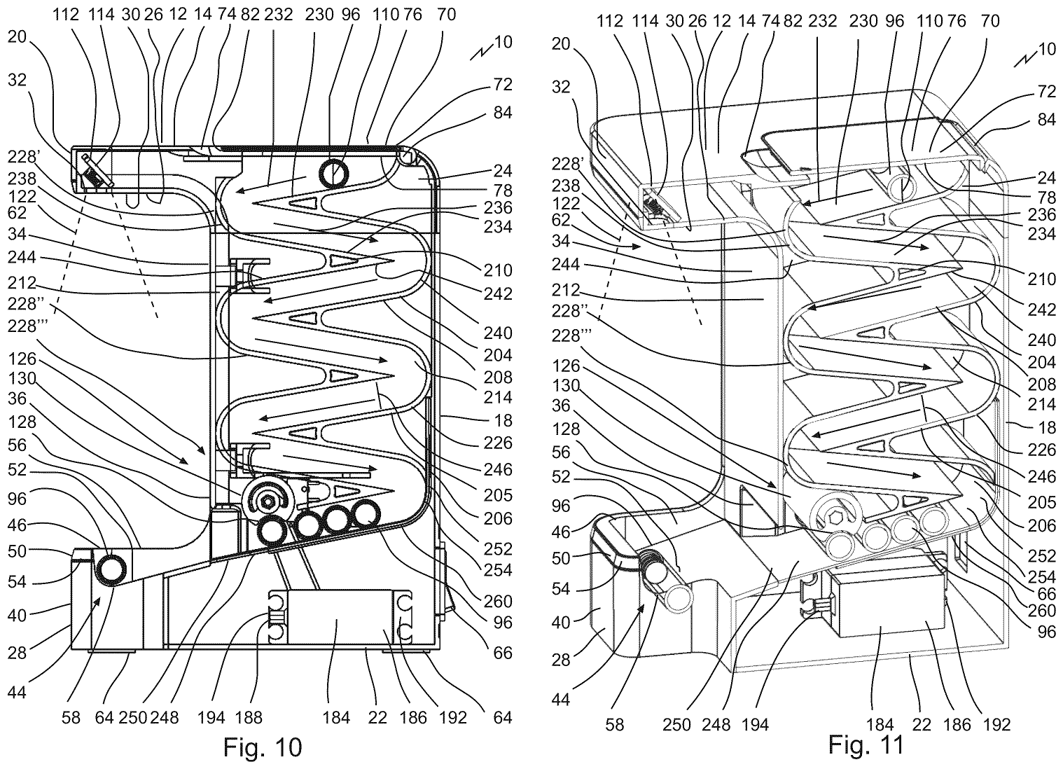

Referring to FIGS. 1-8, a medical cartridge dispenser 10 is illustrated. The dispenser 10 may comprise a storage container 12 structured to retain a plurality of medical cartridges 96 in use. When loaded, medical cartridge dispenser 10 may comprise a plurality of carpules retained as medical cartridges 96 within the storage container 12. Referring to FIGS. 10-16, the medical cartridge dispenser 10 may comprise a cartridge singulator 126. Referring to FIGS. 4, 10-11, and 16, the medical cartridge dispenser 10 may have a user proximity sensor 112. Referring to FIGS. 1-8, 10-11, and 16, the sensor 112 may be connected and used in operation to trigger the cartridge singulator 126 to dispense a medical cartridge 96 from an outlet 38 of the storage container 12. The triggering action may be initiated by the fact of sensing the presence of a user's hand 88 in an activation zone 62 adjacent the medical cartridge dispenser 10. Once a user's hand 88 (or in theory another body part such as an arm) is detected, the dispenser 10, such as a controller 266, may trigger cartridge singulator 126 to advance a single medical cartridge 96, from a plurality of medical cartridges 96 retained within a storage container 12, through the outlet 38.

Referring again to FIGS. 1-8, the storage container 12 may have various suitable characteristics. The storage container 12 may comprise a top 14, walls such as side walls 16, a rear wall 18, and a front 20, a base 22. The various walls may define and enclose, an interior 24. Walls and other structural elements of container 12 may lend the dispenser 10 rigidity and prevent incidental damage to internal components, and may also provide mount points for other components, and the ability to efficiently heat and maintain the contents of the container 12 at suitable temperatures. Such structural parts may also protect internal components from fluid and dust ingress, and may improve the aesthetic appearance of the medical cartridge dispenser 10. For example, the walls and other parts of the container 12 may comprise injection-molded nylon panels. A container 12 may be equipped with support feet 64, which may prevent slipping on smooth surfaces such as a counter surface. Referring to FIG. 10, the storage container 12 and/or dispenser 10 more generally may define a sensor overhang 26, which may be used to affix and orient a user proximity sensor 112 so that its respective field of view 122 is oriented in a suitable fashion to detect the presence of the user, for example by orienting same in a downward direction over the site of cartridge dispensing. The sensor 112 may be attached in a suitable fashion, such as to an underside 30 of the sensor overhang 26, with its field of view 122 unobstructed by placement of the sensor 112 in a corresponding sensor slot 32 defined in the underside of the sensor overhang 26. The front 20 of the medical cartridge dispenser 10 may be defined by a front edge wall 28, and a dispensing panel 34. The dispensing panel 34 may define an outlet 38 through which medical cartridges 96 may be dispensed. A base shelf 40 may form part of the front 20. The shelf 40 may project from the front of the dispenser 10 (or another suitable part of dispenser 10), and may define a cartridge catch 50. The base shelf 40 may serve to support a medical cartridge dispenser 10 after it has been dispensed through outlet 38, but has not been retrieved by a user 86. The container 12 is illustrated in FIGS. 1-8 as largely enclosed, but may in other cases be formed by an open structural frame, such as a largely unenclosed scaffold or space-type frame. The storage compartment or container 12 may include other suitable parts, such as a power switch 66, for example located in the rear wall 18, to engage and interrupt a power supply to internal electrical components. The container 12 may include a power supply connector 68, for example provided in the rear wall 18, to receive electricity, for example, a female barrel-type connector or other suitable connector.

Referring to FIGS. 1-3, 5, and 10-11, the container 12 may include a suitable part to permit access to the interior 24 of the container 12, such as a lid 70 or other gate or door. The lid 70 may be structured to nest and fit within a lid-nesting pocket 72 defined in the top 14 of the container 12. The lid 70 may cover and uncover an access opening or other input, such as defined by pocket 72, through which the container 12 may be loaded with medical cartridges 96. The lid 70 may have a top surface 76, a bottom surface 78, a perimeter edge 80, and a hinge 84 or other suitable connection to container 12. The lid 70 may be generally closed when the dispenser 10 is in use, and opened on an as-needed basis to input cartridges 96 into the interior 24. A finger-receiving pocket 74 may be defined contiguously with pocket 72, at a suitable location, such as adjacent a front edge 82 of the lid 70, to permit a user to use his or her fingers to access and contact either or both the front edge 82 or bottom surface 78 of lid 70 to allow the user the ability to manually open the lid 70. In other cases, the lid 70 may be operated by an automatic mechanism, such as by using a control on the dispenser 10 or by a proximity sensor.

In dentistry and other medical fields, it can be advantageous to heat (prewarm) injectable fluids to body temperature (approximately 98.6° F. or 37° C.). Fluids and materials that are at or near body temperature are less likely to cause discomfort or sensations of cold or hot when they come into contact with the patient's oral tissues. Prewarmed anaesthetics may be less noticeable and less discomforting when provided at body temperature to a patient. Prewarming fluids may be important in general, such as when using irrigation solutions, impression materials, or restorative materials during procedures. Prewarmed fluids may help maintain the normal temperature of oral tissues, which can avoid adverse reactions or stress on these tissues from temperature shifts. Some dental materials, such as impression materials or restorative composites, may have improved flow and viscosity characteristics when warmed to body temperature. This can enhance their handling properties, making them easier for the dentist to work with and ensuring better outcomes in procedures like impression taking or filling cavities. Certain dental materials, such as resin-based composites used in tooth-colored fillings, may have quicker polymerization (hardening) times when applied at or near body temperature. This can be beneficial for the dentist as it allows for more precise placement and shaping before the material sets. Prewarmed impression materials can enhance the accuracy of dental impressions, ensuring that they capture fine details and provide better-fitting restorations or appliances.

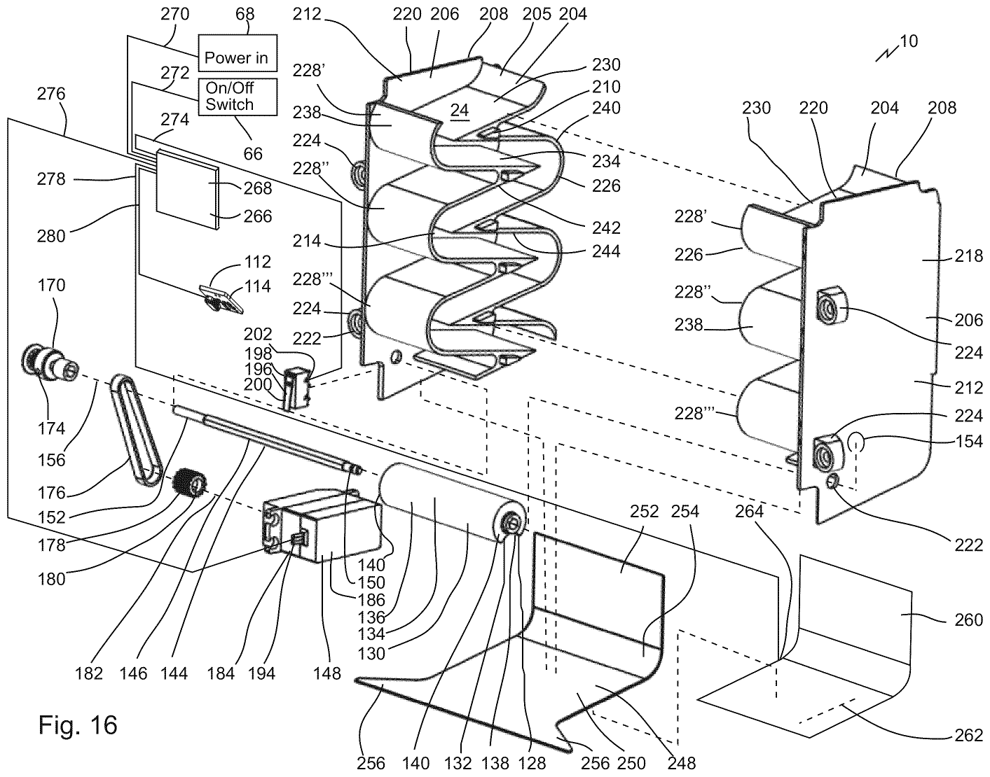

Referring to FIG. 16, a medical cartridge dispenser 10 may include a cartridge heater 258. One suitable example of a cartridge heater 258 includes a resistive heating pad 260. Heater 258 may be connected to a controller 266 via a suitable control connector 264 and control lead 278 (such as an electrical, optical, pneumatic, hydraulic, or other suitable line or wire). The use of the heater 258 may provide the ability to pre-heat the plurality of medical cartridges 96 within the dispenser 10 prior to dispensing such cartridges 96. A temperature sensor 262, such as a thermocouple or resistance temperature detector (RTD), may be provided to monitor a temperature of the cartridges 96 and/or interior 24 of the container 12, and provide data used in a feedback loop to control an internal temperature of a storage container 12 using a heater 258. A feedback signal from the temperature sensor 262 may be received by the controller 266 and used accordingly to control the heater 258. Although an external controller 266 is illustrated, in some cases, the heater 258 may include one or more of an internal controller and temperature sensor to maintain a desired output temperature or temperature range. In the example where the heater 258 monitors its own temperature, the dispenser 10, for example the controller 266, may provide control signals to the heater 258 to produce a particular temperature of output heat. The internal temperature of the container 12, or at least a part of the container 12 that contains cartridges 96 to be used, may thus be maintained at a constant, precise setpoint or range of setpoints of temperature. The dispenser 10 may be configured to permit the user to adjust an output of the heater 258 to provide a selected temperature or range of temperatures. The heater 258 may be configured to maintain medical cartridges 96 in a storage container 12 at body temperature or within a range of suitable body temperatures. In some cases, the heater 258 may be configured to maintain the cartridges 96 at a selected temperature between a suitable range, for example between 35-42 degrees Celsius, for example within 36.0-38.0 degrees Celsius, of which temperature may be selected by the user or preset. The heater 258 and/or a sensor 262 may be located at a suitable position, such as at or near an outlet 38 of a storage container 12. When located at or near the outlet 38, the heater 258 may be able to more precisely maintain a temperature of cartridges 96 that are about to be dispensed at the appropriate temperature, as opposed to cartridges 96 that are further back in the order of dispensing. In the example of FIG. 16, a resistive heating pad 260 may underlie, overlie, or define at least part of a cartridge exit chute 250 upstream of or at an outlet 38 in the storage container 12. The controller 266 may include a printed circuit board 268 pre-programmed to operate the dispenser 10. The example of a constant setpoint at approximately body temperature is used, but it can be understood that in other embodiments a user-adjustable control could be provided, with, optionally, a display of the actual current cartridge temperature.

Singulation, in the context of assembly lines, material processing and dispensation, refers to the process of separating individual components or products from a larger batch or continuous stream of materials. Singulation may be essential for precision manufacturing and assembly, ensuring that each unit is isolated and ready for further processing or packaging. Various singulation methods exist, including mechanical, optical, and electromagnetic approaches. Mechanical methods employ mechanisms such as conveyor belts, vibration, or air jets to physically separate items. Optical methods utilize sensors and cameras to detect and locate items for separation. Electromagnetic methods can leverage magnetic fields to attract or repel items with different properties. Additionally, laser-based techniques, ultrasonic methods, and sorting mechanisms like rotating drums can all contribute to successful singulation. The choice of singulation method depends on factors such as the type of materials, desired precision, throughput rate, and the specific requirements of the manufacturing or assembly process. Methods of singulation may include mechanical separating machines such as a conveyor belt with appropriately spaced dividers or paddles, air jet or vacuum systems, vision systems that identify individual objects, or mechanical sorters that use rotating drums or other actuators to direct objects through chutes or gates.

Beverage-handling vending machines, as an example, include singulation mechanisms and systems that may operate with a variety of suitable parts. Many vending machines use proximity sensors or optical sensors placed strategically along the dispensing chute or delivery mechanism. These sensors can detect the presence of a beverage container as it moves through the system. Infrared sensors may be used to emit an infrared light beam, and when an object interrupts the beam (such as a beverage container passing by), the sensor detects the interruption and sends a signal to the control system. The control system of the vending machine may process information from the sensors in real-time. The control system may monitor the position and movement of containers within the dispensing area. Advanced control algorithms may ensure that only one container is released at a time. If the sensors detect multiple containers in close proximity or a potential jam, the control system temporarily halts the dispensing process. The vending machine's mechanical design may incorporate mechanical gates, baffles, or gates with one-way movement allow the machine to control the release of containers. For example, a gate may open to let one container through and then close behind it, preventing others from following. Conveyor belts or spirals are often used to transport the beverage containers from their storage location to the dispensing point. These systems can be controlled precisely to ensure that only one container is moved at a time. Mechanisms may be provided to detect and resolve issues like jams. If sensors detect that a container is stuck or not moving as expected, the control system can reverse the conveyor or take corrective action to prevent multiple containers from being dispensed. By combining sensor-based detection, control logic, mechanical mechanisms, and error-handling mechanisms, vending machines can reliably ensure the dispensing of only a single beverage container at a time. These technologies work in tandem to prevent jams, ensure smooth customer transactions, and maintain the integrity of the vending process. The aforementioned teachings or part thereof may be incorporated or applied to the present application of a singulator used in a medical cartridge dispenser 10.

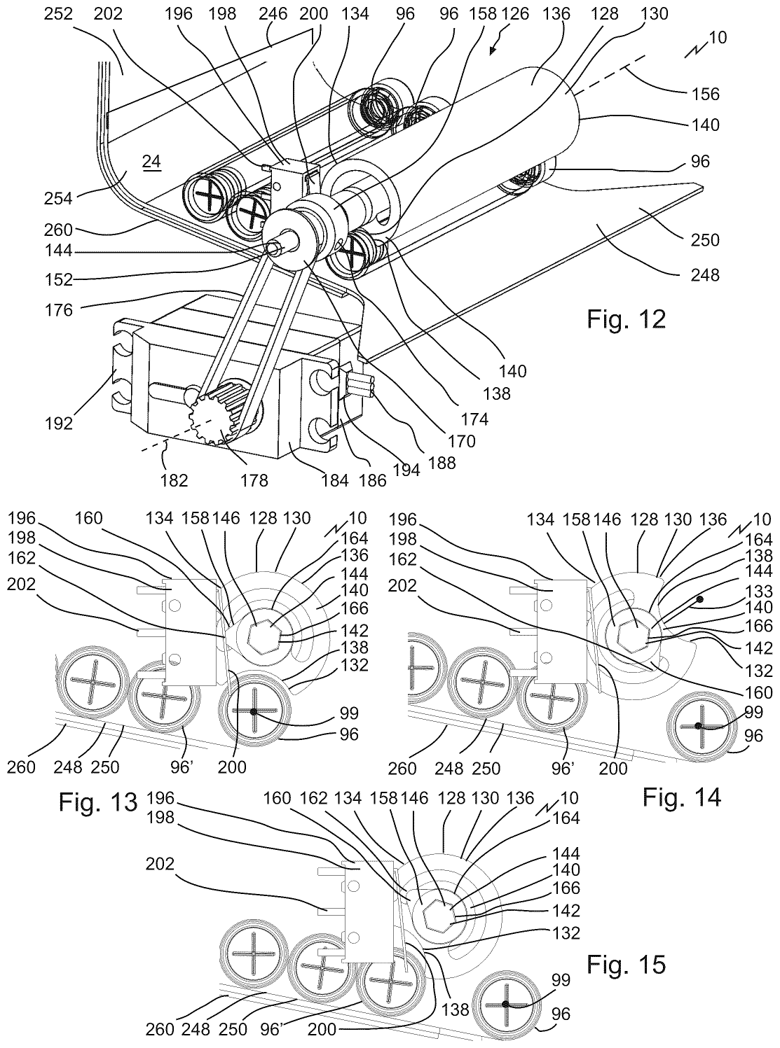

Referring to FIGS. 12-16, the cartridge singulator 126 may incorporate a rotatable cam 128. The cam 128 may be structured to advance a single cartridge 96 along a sequential conveyor track 204. As illustrated, the rotatable cam 128 may define a cartridge-advancing part 132 and an upstream-cartridge-blocking part 134. The cartridge singulator 126 may comprise a dispensing drum 130 that defines the rotatable cam 128. The dispensing drum 130 may define the rotatable cam 128 in an axial direction along a cylindrical drum sidewall 136 of the dispensing drum 130, for example extending all or part of an axial distance between opposed cylindrical ends 140 of drum 130. In the example shown, the rotatable cam 128 is formed as an axial slot 138 in the cylindrical sidewall 136, with the cartridge-advancing part 132 defined by the axial slot 138, for example as a seat for a cartridge 96 that is on-deck to be dispensed next, and the upstream-cartridge-blocking part 134 defined by the cylindrical drum sidewall 136, for example as a stop to engage and prohibit further advancement of the cartridge 96 immediately downstream of the cartridge 96 that is seated within the part 132. The drum 130, in cross-section, may define the upstream-cartridge-blocking part 134 as an arc of a major sector of the cylindrical sidewall 136 of the drum 130. In the example shown, the drum 130, in cross-section, defines the cartridge-advancing part 132/axial slot 138 as an inverted arc, or indent, of a minor sector of the cylindrical sidewall 136 of drum 130. Referring to FIG. 14, the part 132/axial slot 138 may, in cross-section of the drum 130, form a circular arc as shown that defines a radius 133 corresponding to (for example equal to or larger than) a radius 97 of a selected cartridge 96 of which the slot 138 is sized for. Other shapes of parts 132 and 134 may be used, for example polygonal, oblong, elliptical, or other shapes, incorporating one or more of straight or curved profile lines. In the example shown in FIG. 13, when the cartridge 96 is seated (loaded) in the slot 138, the cartridge 96 in cross-section circumscribes the circle of the drum 130 outer profile. Referring to FIGS. 12-16, the cartridge singulator 126 may be structured to roll individual cartridges 96 (rolling referring to the motion of a cartridge 96 rotating about its rolling or longitudinal axis 99) along a cartridge exit chute 250 and out an outlet 38. The dispensing drum 130 may be oriented such that a rotational axis 156 of the dispensing drum 130 is parallel with the rolling axis 99 of a cartridge 96 seated in the dispensing drum 130 during use. In the example shown, the drum 130 is oriented above the chute 250 at the outlet 38 to engage respective cartridges 96 from above and to convey those cartridges 96 out the outlet 38.

Referring to FIGS. 12-16, the dispensing drum 130 may include a mechanism to transmit torque received from a drive mechanism, such as a motor 184. In the example illustrated, the torque transmission part may comprise an internal drive socket 142, for example a female hexagonal socket, to allow it to be driven by a mating hexagonal drive shaft, for example on a drive axle 144. Other embodiments might comprise alternate drive sockets, such as a female keyway.

Referring to FIGS. 12-16, the singulator 126 may execute a dispensing action by a suitable method. Immediately prior to when the singulator 126 is triggered to execute a dispensing action, the singulator 126 may be oriented in a neutral position. In the example of FIG. 13, the neutral position is shown as a loaded, neutral position, where the slot 138 engages a cartridge 96. Referring to FIGS. 14-15, upon being triggered or tripped, the singulator 126 may rotate the dispensing drum 130 to advance the single medical cartridge 96 through the outlet 38. While the drum 130 is rotating, the cartridge-blocking part 134 may act as a stop that prohibits a cartridge 96′, which is on-deck in the sense of being the next in the order of cartridges 96 to be dispensed, from crossing the outlet 38. Referring to FIGS. 13-15, once the drum 130 has expelled the cartridge 96, the drum 130 may return to a neutral position, where the cartridge 96′ is now seated within or in contact with the cartridge-advancing part 132. The neutral or start position may be arranged in other ways, such as in the configuration of FIG. 14 or 15, with the upstream cartridge 96′ engaged or otherwise ready to be dispensed but out of contact with slot 138/part 132. In some cases, a separate part is used to define the cartridge-blocking part 134, for example a stop, lever, cam, gate, or other mechanism, apart or external to the structure of the drum 130 itself, for example a gate upstream of the drum 130 may act as the blocking part 134.

Referring to FIG. 12, the singulator 126 may incorporate a suitable drive. When a dispenser 10 is triggered directly or indirectly by signals from a proximity sensor 112 indicating that a dispensing action should be carried out, the motor 184 may begin to rotate. The motor 184 may be mounted, for example affixed, to a surface of container 12, for example an upper face of a panel making up the base 22 within interior 24 of container 12. Mounting may be achieved via suitable mechanisms such as by way of fasteners and a motor mounting flange 192. The motor 184 may be enclosed by a motor housing 186, and may be connected to a power and control line by motor electrical leads 188 and a motor control connector 194. The motor 184 may be connected to drive the cam 128 via a suitable transmission system, such as a gear-reducer. The motor 184 may be connected to drive the cam 128 via a suitable power transfer system such as a belt drive (shown), or other drives such as a chain and sprocket, rack and pinion, pulley, or other mechanical power transfer system. The motor 184 may begin to rotate the drive gear 178, which may be mounted on a shaft of the motor 184, which may pass into a drive gear drive socket 180 and transfer torque to drive gear 178. The drive gear 178 may rotate about a drive gear axis 182 and transfer power into a drive belt 176, which may be a toothed or smooth belt. The belt 176 may transfer mechanical power to a driven gear 170 or other transmission component, such as a smooth pulley. As illustrated in FIG. 12, a driven gear 170 may have an internal driven gear drive socket 172, which may transfer torque into axle 144 via an axle drive section 146 (illustrated in FIG. 16), which may have a non-circular section that fits closely inside driven gear drive socket 172. A driven gear 170 may have a driven gear lock thread 174 aperture, through which a set screw may be passed to axially restrain the driven gear 170 relative to an axle 144. Referring to FIG. 16, one or more of the driven gear 170, timing cam 158, and dispensing drum 130 may be structured coaxially with the axle 144. The axle 144 may define a drive section 146 that is able to transfer torque through a non-circular profile (out of round closed path in cross-section), an axle bearing surface 148 that may be used to mount or pilot a bearing, bushing, or other means of restraining axle 144 while permitting free rotation. An axle retainer groove 150 may be provided along the axle bearing surface 148, which may accommodate a retaining ring 154. An axle mount surface 152 may be provided, which may be circular to permit easy mounting of components (e.g., a driven gear 170) that do not have an internal drive profile.

Referring to FIGS. 12-16, the singulator 126 may be configured to rotate the cam 128 through a single rotation, for example a 360-degree rotation, to dispense a single cartridge 96, in use. FIG. 13 shows the beginning of one such rotation, in which a cartridge 96 to be dispensed is restrained initially from rolling down the cartridge exit chute 250 by the axial slot 138 in the dispensing drum 130. Simultaneously, other adjacent cartridges 96, including the ‘on-deck’ cartridge 96′, are prevented from rolling down exit chute 250 by the upstream-cartridge-blocking part of dispensing drum 130. Referring to FIG. 12, the cartridge singulator 126 may comprise a motor 184.

The singulator 126 may incorporate an encoder for providing feedback on the position and range of motion of the singulator 126. An encoder may include a sensing device that provides feedback. Encoders convert motion to an electrical signal that can be read by some type of control device in a motion control system, such as a counter or PLC. The encoder sends a feedback signal that can be used to determine position, count, speed, or direction. Mechanical encoders include devices used for converting mechanical motion into electrical signals to measure position or rotation. Several types of mechanical encoders exist, each with its unique structure and operation. Rotary encoders are designed to measure angular position or rotation, and comprise a rotating shaft attached to a disc with slots or a coded pattern. Incremental rotary encoders may incorporate a disc with slots and a light source/sensor to generate electrical pulses as the disc rotates. Absolute rotary encoders may use a coded pattern on the disc to provide a unique code for each position, allowing immediate determination of the absolute position. Linear encoders may be used to measure linear or linear-angular position, and may comprise a linear scale (glass or metal) with a read head that moves along it. Optical linear encoders may use an optical sensor (typically a light-emitting diode and photodetectors) to read marks or graduations on the scale. Magnetic linear encoders may employ magnets and Hall effect sensors to detect the position by measuring changes in magnetic fields. Shaft encoders may be attached to the shaft of a rotating machine or motor to measure its position or rotation, and may be incremental or absolute, depending on their design. Magnetic encoders may use magnets and sensors to detect changes in magnetic fields caused by rotation or linear movement, and may be used in harsh environments where optical encoders may be less suitable. Disk encoders may use a rotating disk with slots, holes, or coded patterns to generate electrical signals as it moves relative to a sensor. Gear encoders may use gears with known ratios to translate mechanical motion into electrical signals, and are often used in applications where high precision and backlash elimination are required. Encoders may be categorized as either incremental or absolute. Incremental encoders generate pulses as they move, requiring a reference point for position determination. Absolute encoders provide a unique code for each position, allowing immediate position identification. The choice of mechanical encoder type depends on factors like required precision, environmental conditions, and the nature of the motion being measured. Each type offers specific advantages and trade-offs, making them suitable for a wide range of industrial and automation applications.

The singulator 126 may comprise a timing cam 158, for example to time operation and range of motion of the drum 130 during use and/or to provide feedback on angular position of the drum 130. As illustrated in FIGS. 13-16, a timing cam 158 may be structured to engage a limit switch 196, such as a microcontroller as shown, during each action of dispensing a medical cartridge 96 by the singulator 126. The timing cam 158 and assembly shown may be considered as a simple form of an absolute rotary mechanical encoder. Referring to FIGS. 13-15, the timing and range of motion of the cam 128 may be directed by feedback from the timing cam 158. Rotation of timing cam 158 may bring a timing cam boss 160, for example specifically a boss tip 162, into contact or engagement with a limit switch 196. The limit switch 196 may comprise a limit switch body 198, and a limit switch actuator 200 that is depressed or otherwise actuated by the movement of a boss tip 162. Thus, in the embodiment illustrated, a single complete rotation of timing cam 158 switches the state of a limit switch 196 twice, for example by starting the rotation in a closed, engaged state (FIG. 13), opening the switch into an opened, advancement state after initial rotation (FIGS. 14-15), and re-engaging and closing the switch after entering the neutral-loaded or seated position (FIG. 13). The limit switch 196 may be connected to the controller 266 via electrical lead 274 as illustrated in FIG. 16. Referring again to FIGS. 13-15, the timing cam 158 may incorporate a timing cam end surface 168 and a timing cam cylindrical sidewall 164. The combination of a limit switch 196 and a timing cam 158 may thusly provide a positive feedback signal to controller 266 that a single cartridge 96 has been dispensed. Other types of encoding mechanisms may be used, including other ways of operating the encoding mechanism shown in FIGS. 13-15.

Glass containers, such as medical cartridges 96 whose cylindrical body 102 comprises glass, may be susceptible to glass lock, i.e., unintended frictional locking in certain circumstances. Friction lock of glass cartridges may occur when same are stacked in larger, hopper-style containers that permit layers of cartridges 96 to rest on other layers of cartridges 96 in any orientation. Friction lock of glass cartridges may occur in arrangements where cartridges are stacked with their cylindrical axes 99 largely horizontal, and several layers (for example, >2) are stacked. The coefficient of friction between dry glass against dry glass is relatively high (for example, >0.8), and so when the weight of upper layers of cartridges is borne by lower layers, frictional forces are cumulative and may prevent the withdrawal and dispensation of a cartridge 96 from a lower layer. Moreover, the weight of upper layers may itself risk cracking or damaging cartridges 96 occupying lower layers of the stack, especially if exacerbated by incidental loads and jarring cause during moving the container. To address glass lock issues in bulk storage of glass vials, manufacturers may implement measures such as using anti-stick coatings, introducing spacer materials, or modifying vial designs to reduce surface contact. These measures help minimize friction and facilitate the smooth and reliable dispensing or handling of glass vials, ensuring the integrity of the contents and preventing damage during separation.

Referring to FIGS. 10-11 and 16, the storage container 12 may be structured to order cartridges 96 stored within interior 24 of container 12 in a manner that reduces or eliminates negative effects of glass lock on dispensing action. The part of container 12 that retains cartridges 96 may be structured to order the cartridges 12 to provide a sequential conveyor track 204. A sequential conveyor track 204 may support one or more cartridges 96 in a specific mutual orientation and position to facilitate the reproducible and reliable action of a singulator 126. It may serve to limit frictional forces among cartridges 96, and may limit gravitational forces exerted on any single cartridge 96 from the weight of overlying cartridges 96.

A serpentine chute, sometimes used in bulk item dispensers and material handling systems, may be a specially designed channel or conduit with a serpentine or zigzag shape. This configuration may serve the purpose of controlled and sequential item dispensing. Bulk items may be loaded into the chute's entry point. Gravity or controlled mechanisms guide these items along the serpentine path, causing them to flow in a controlled and evenly spaced manner. The serpentine design ensures that only one item is released at a time, preventing jams, blockages, or irregular dispensing. This type of chute may be employed in various industries, including food processing, manufacturing, and automated packaging, to facilitate efficient and reliable bulk item dispensing while maintaining product integrity and consistency.

Referring to FIGS. 10-11 and 16, the internal sequential conveyor track 204 may incorporate a serpentine chute 205. A serpentine chute 205 may be supported by a structural frame 206, which may act to support, stabilize, form, and stiffen chute 205. I structural frame 206 may comprise plural parts assembled together in a final configuration, such as first and second halves 208 that may be mated together. This specific construction may be useful for assembly and manufacturability of frame 206, and may facilitate cleaning and repair after disassembly. First and second halves 208 may be retained to each other by a suitable mechanism, such as the mating of corresponding male and female connectors 210, or any other suitable fastener or joining method, such as screws, ties, or clips. Frame 206 may incorporate end walls 212, which may themselves define track sidewall end-guide surfaces 214. In the example shown, the chute 205 may be structured to support medical cartridges 96 in a manner that the axes 99 of each cartridge 96 are oriented substantially perpendicular to end-guide surfaces 214, and to facilitate this the frame 206 may be configured such that guide surfaces 214 are spaced to define a separation distance 216 (see FIG. 12) between end-guide surfaces 214 that exceeds the axial length of cartridges 96 sufficient to permit a natural gravity rolling movement of cartridges 96 throughout the chute 205 in operation. Referring to FIGS. 10-11 and 16, structural frame 206 may be provided with a mechanism for mounting axle 144 of drum 130, for example axle bearing holes 222 may be defined in end walls 212 to locate and support the axle 144, for example by means of a bearing, a bushing, or a smooth cylindrical surface. Various mechanisms may be provided to mount the frame 206 within the interior 24 of the container 12, for example integral or non-integral connections, such as by equipping structural frame 206 with fastener bosses 224 on end wall outer surfaces 218, to facilitate fixing it to other components of a cartridge dispenser 10 with fasteners. In the example shown a perimeter edge 220 of frame 206 may be shaped to tightly fit within the interior 24 in contact with all six inner structural members of container 12, namely the walls 16, 18, front 20, top 14 and base 22.

Referring to FIGS. 10-11 and 16, the structure that provides serpentine chute 205 may define two or more repeating switchback segments. In the example shown, chute 205 comprises a guide body 226 (formed in the example by halves 208), which may comprise repeating switchback segments 228′, 228″ and 228′″. Segments 228′, 228″ and 228′″ may define a circuitous path that permits storing cartridges 96 in a container 12 in a manner that orders cartridges 96 in a series, so that no cartridge 96 engages more than two adjacent cartridges 96 at once, one upstream and one downstream of the cartridge 96. The segments 228 permit ordering at a high density in the greater container 12, while minimizing mutual friction or weight loads among the cartridges 96. A segment 228 (segments may be referred to by the number 228, with the understanding that one, or more, or all segments 228′, 228″, or 228″ in the drawings may have such parts) may comprise a first guide chute 230 that is oriented at a declination that causes cartridges 96 to roll or slide in a first direction 232 of rolling travel. The first direction 232 may be followed by a cartridge 96 until the cartridge 96 contacts a first arcuate chute deflector guide 238. The segment 228 may define a second guide chute 234 that follows the deflector guide 238 that is oriented at a declination that causes cartridges 96 to roll or slide in a second direction 236 of rolling travel, until they make contact with a second arcuate chute deflector 240 (or outlet 38 in the case of the lowest segment 228′″ in the example shown). The directions 232 and 236 may be oriented opposite to one another when projected in a common horizontal plane. Suitable angles of declination may be selected to permit sufficient rolling action of each cartridge 96 to navigate each section by gravity without locking up or binding with adjacent cartridge 96. The internal dimensions of the chute 205 may be configured to facilitate ordered incremental advancement of a series of cartridges 96. As a cartridge 96 travels along the first direction 232 of rolling travel, the cartridge 96 may be confined between a first upper guide surface 242 (i.e., the ceiling of guide chute 230), and as it travels along the second direction 236 of rolling travel, it may be confined by a second upper guide surface 244 (i.e., the ceiling of the guide chute 234). First guide chute 230 and first upper guide surface 242, and second guide chute 234 and second upper guide surface 244, may each be separated by a guide surface separation distance 246, which may be sufficiently larger than an outer diameter 110 of a cartridge 96. When a cartridge 96 has navigated repeating segments 228′, 228″ and 228′″ by gravity, the cartridge 96 may roll or slide onto a cartridge exit guide 248, which may support it while it slides or rolls through outlet 38. The use of a serpentine chute is one example of a suitable mechanism to supply cartridges 96 in an ordered fashion to singulator 126, and it should be understood that other methods of storing cartridges 96 in bulk in container 12 may be used, including using a general hopper-style chute, and other structures, whether such structures arrange cartridges 96 in a sequential, ordered fashion, in a disordered or semi-ordered bulk fashion, or anything in between. However, the use of a serpentine chute as shown has been found to improve the movement of cartridges 96 through the dispenser 10, resulting in more predictable and reliable dispensing of individual cartridges 96 on demand when compared with container 12 structures that provide more chaotic internal storage and arrangement.

Referring to FIGS. 10-11 and 16, the container 12 may incorporate a cartridge exit guide 248 for receiving cartridges 96 from chute 205 (or other track structure as the case may be) and supplying such cartridges 96 to singulator 126. Cartridge exit guide 248 may define one or both of a cartridge exit guide rear wall 252 and a cartridge exit arcuate deflector guide 254, which may act independently or together to change the direction of the path of an incoming cartridge 96 from chute 205 and direct the cartridge 96 toward outlet 38 (illustrated in FIGS. 1-2). The cartridge exit guide 248 may have a suitable declination (downslope) to permit gravity rolling of ordered cartridges 96 to a downstream end of guide 248, which may be defined by flanged catch ends 256 that conform to other components such as a base shelf 40 illustrated in FIG. 1.

Referring to FIGS. 1-2, 4, 6, and 10-11 the dispenser 10 may incorporate a suitable cartridge catch 50. The cartridge catch 50 may be provided downstream of the outlet 38 to locate and support a medical cartridge 96 after dispensation from outlet 38. A suitable cartridge catch 50 may be defined at least in part by base shelf 40. Cartridge catch 50 may be formed of one or more cartridge stop walls 54 adjacent (and in the example shown spaced to define) a finger-receiving pincer zone 58. The side walls 56 and stop walls 54 may collectively form a secured perimeter wall around base shelf 40 as shown, to retain a dispensed cartridge 96 upon a cartridge catch chute 52 that supports a dispensed cartridge 96 and induces the cartridge 96 with a suitable declination to roll towards pincer zone 58. Some or all of cartridge chute 52, stop walls 54, and side walls 56 may enclose a dispensed cartridge 96 and prevent its incidental movement until it is picked up by a user 86. The base shelf 40 and walls 54 may collectively define a front mouth 44 that forms a finger-receiving pincer gap zone 58, which may itself be an opening sized to permit a user 86, and in some cases 360, degrees as shown of access about cylindrical sidewall body 102 of a dispensed cartridge 96 without contacting the dispenser 10. The front mouth 44 may in part be defined by gap side walls 46 and a gap rear wall 48. The aforementioned structure is one that may permit a dispensed cartridge 96 to be retained on the dispenser 10, but may allow a user's hand 88 to grip dispensed cartridge 96 from both above and below the with a gloved hand 88, without making any contact with the non-sterilized cartridge dispenser 10. Such may assist the user to avoid contamination and needless discarding of contaminated gloves, handwashing, reapplication of new gloves, or otherwise delaying a procedure as required to maintain sterility, as a user has the ability to obtain a cartridge 96 without touching the dispenser 10. It can be understood that a suitable pincer gap zone 58 may be structured to define dimensions, such as a lateral separation distance 60, which is large enough to accommodate a lateral width (not shown) of a pincer movement of at least a thumb 94 and index finger (2^{nd} finger 92), and in some cases large enough to accommodate a lateral width 90 of a span of the 2^{nd}-5^{th} fingers 92, defined relative to the dimensions of the hand and fingers of an average adult male. Such may permit the 2^{nd}-5^{th} fingers 92 of an average user 86 to pass through a pincer gap zone 58, while a thumb 94 also passes through gap zone 58 on the opposite side a dispensed cartridge 96, to permit a variety of pincer motions or cupping motions to lift and remove the dispensed cartridge 96 from the dispenser.

Referring to FIGS. 4, 10-11, and 16, the dispenser 10 may incorporate a proximity sensor 112. Proximity sensors include components in electronic devices that detect the presence or absence of objects, in some cases human tissue and/or appendages, within a specified range without physical contact. There are several common types. Inductive proximity sensors use electromagnetic fields to detect metal objects within their detection range, but may be less effective for detecting nonmetallic objects. Capacitive proximity sensors detect changes in capacitance when an object enters their proximity, and can be used to detect a wide range of materials, including non-metallic substances like plastics, liquids and living tissue. They may be used, for example, to detect the liquid level inside a tank. Ultrasonic proximity sensors emit high-frequency sound waves and measure the time it takes for the waves to bounce back after hitting an object. They are used for non-contact distance measurement and object detection. Photoelectric proximity sensors use light beams (infrared or visible) to detect the presence or absence of objects. They are available in various configurations, including through-beam or reflective types. Magnetic proximity sensors detect changes in magnetic fields caused by the presence of ferrous objects. They are commonly used in applications like door and position sensing. Laser sensors emit a focused laser beam and measure the reflection to determine an object's presence and distance. They offer high precision and are used in applications requiring accurate distance measurements.

An optical proximity sensor may be used in dispenser 10. Optical proximity sensors are inexpensive and versatile because they are relatively insensitive to the composition of the detected object. They are widely used in smartphones and tablets, automatic hand dryers, automatic faucets, elevators, printers and copiers, automatic doors, vending machines, and automation equipment. A through-beam sensor uses a light emitter, such as a light-emitting diode (LED) or infrared light source, to emit a light beam along a known path towards a receiver. When the light path is interrupted by the sensed object, the receiver does not receive the emitted light and the state of the sensor switches. Reflective optical proximity sensors use an emitter and a sensor that are closely collocated, and the sensor detects light reflected by the detected object itself. Reflective sensors may be sensitive to the reflectivity of the detected object, and may not detect highly reflective or very absorptive objects reliably. The receiver or photodetector in an optical proximity sensor may be a phototransistor or photodiode, both semiconductor devices with a known response to light.

Referring to FIGS. 4, 9-11, and 16, the medical cartridge dispenser 10 may comprise a user proximity sensor 112 that operates in a suitable fashion. The sensor 112 may be configured to initiate the triggering of the cartridge singulator 126 upon detection of a user's hand 88 at a suitable location adjacent the dispenser 10, for example above a cartridge catch. Referring to FIG. 9, a user proximity sensor 112 may be of the optical type, and may comprise a printed circuit board 114, passive circuit elements 116 such as capacitors and resistors, a light source 118, and a light receiver 120. A control connector 124 may be provided on a printed circuit board 114 and may transmit a signal from sensor 112 to a controller 266 via an electrical lead 280 (illustrated in FIG. 16). Referring to FIGS. 4, 10-11, and 16, sensor 112 may be mounted such that a field of view 122 is defined, which will itself define a user action zone 62, for example by orienting the sensor 112 in a downward direction from the underside 30 of sensor overhang 26 above catch 50. When an object such as a user's hand 88 enters the user action zone 62, dispensation of a cartridge 96 may be triggered. In some cases, the dispenser 10 may be configured to avoid unintended triggering of the singulator 126. For example, the sensor 112 may be configured to detect motion or hand presence directly below the sensor 112 but above the catch 50 and cartridge 96, to permit a user to trigger the dispensation of cartridge 96 by a hand movement close to sensor 112, but without triggering a further dispensation of cartridge 96 when the user executes a cartridge retrieval movement to remove the cartridge 96 from the catch 50. One or more sensors (not shown) may be structured to detect the presence of a cartridge 96 in the catch 50 and may prohibit the further dispensing of another cartridge 96 until the first cartridge 96 has been removed from the catch 50. One or more timers (not shown) may be used to define an inactive period selected to be sufficient to permit a user time to remove the dispensed cartridge 96 without triggering a further dispensation. Other types of sensors may be used beyond simply an optical sensor.

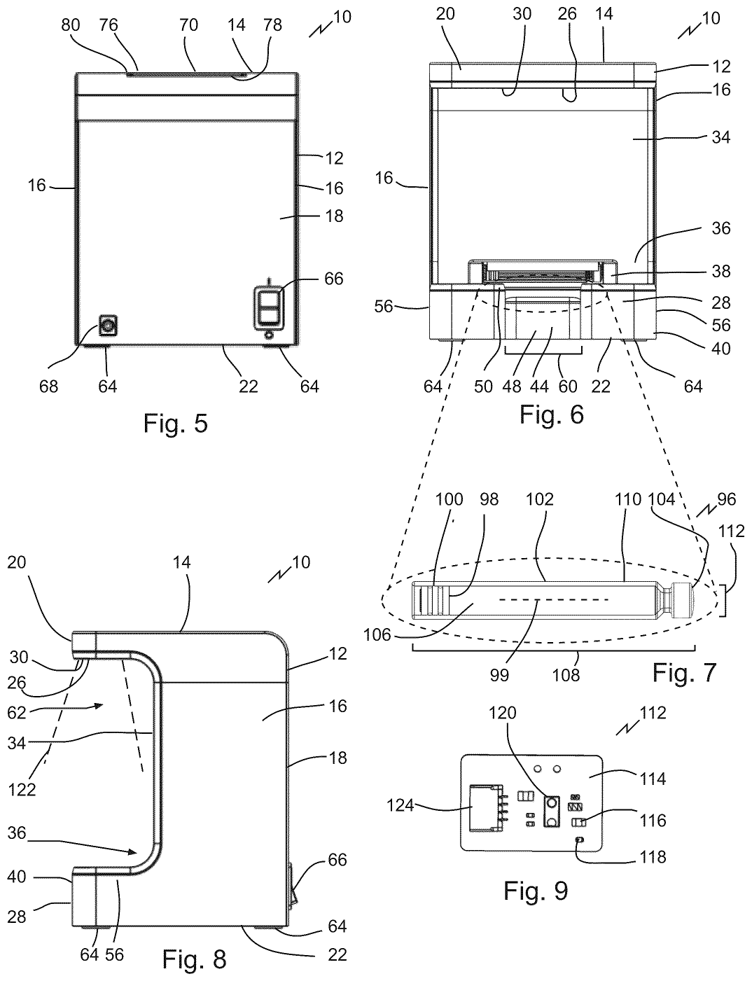

Referring to FIGS. 5 and 16, the dispenser 10 may comprise a controller 266, which may operate to control operation of the dispenser 10 or one or more or all functions of the dispenser 10. The controller 266 may be connected to receive signals from sensors and send control signals as needed, according to a pre-programmed or user-created dispensing algorithm. The controller 266 may be connected to send and receive signals and/or power to and from one or more of a user proximity sensor 112, power switch 66, power supply connector 68, limit switch 196, cartridge heater 258, and motor 184. Controller 266 may comprise a printed circuit board 268. Electrical leads 270, 272, 274, 276, 278, 280 may carry one or more of power, control, and sensor, signals to and from controller 266 and to and from other components of dispenser 10. The controller may comprise a suitable structure such as that of a microcontroller programmed with suitable firmware to dispense a cartridge 96 from an outlet 38, upon the receipt of a signal from proximity sensor 112 triggered by a user.

TABLE
Part List

10 - Cartridge dispenser
12 - storage container / housing
14 - top
16 - side walls
18 - rear wall
20 - front
22 - base
24 - interior
26 - sensor overhang
28 - front edge wall
30 - underside of the sensor overhang
32 - sensor slot in the underside
34 - dispensing panel
36 - base of dispensing panel
38 - outlet at a base of the dispensing panel
40 - base shelf
44 - front mouth
46 - gap side walls
48 - gap rear wall
50 - cartridge catch defined by the base shelf
52 - cartridge catch chute
54 - cartridge stop walls
56 - cartridge side walls forming a secured perimeter
58 - finger-receiving pincer zone defined by the gap walls
60 - separation distance
62 - user activation zone defined between the base shelf and the sensor overhang below the sensor
64 - support feet
66 - power switch
68 - power supply connector
70 - lid
72 - lid-nesting pocket
74 - finger-receiving pocket
76 - top surface
78 - bottom surface
80 - perimeter edge
82 - front edge
84 - hinge
86 - user
88 - user's hand
90 - width of span of average adult 2-5 digit fingers
92 - 2-5 digit fingers
94 - thumb
96 - medical cartridge / carpule
97 - cartridge radius
98 - sliding plug
99 - rolling axis
100 - sealing lip
102 - ampule body
104 - penetrable lid
106 - payload
108 - axial length
110 - outer diameter
112 - user proximity sensor
114 - printed circuit board
116 - passive circuit elements
118 - light source
120 - light receiver
122 - field of view that defines the zone based on orientation of the sensor
124 - control connector
126 - cartridge singulator
128 - rotatable cam
130 - dispensing drum
132 - cartridge-advancing part
133 - radius of axial slot
134 - upstream-cartridge-blocking part
136 - cylindrical drum sidewall
138 - axial slot
140 - cylinder drum ends
142 - internal drive socket
144 - axle
146 - axle drive section
148 - axle bearing surface
150 - axle retainer groove
152 - axle mount surface
154 - retaining ring on far end of axle
156 - rotational axis
158 - timing cam
160 - timing cam boss
162 - boss tip
164 - timing cam cylindrical sidewall
166 - timing cam drive socket
168 - timing cam endsurface
170 - driven gear
172 - driven gear drive socket
174 - driven gear locking thread
176 - drive belt - may have teeth
178 - drive gear
180 - drive gear drive socket
182 - drive gear axis
184 - motor
186 - motor housing
188 - motor electrical leads
192 - motor mounting flange
194 - motor control connector
196 - limit switch
198 - limit switch body
200 - limit switch actuator
202 - limit switch control connector
204 - Sequential conveyor track / switchback track
205 - serpentine chute
206 - track structural frame
208 - first and second halves
210 - male and female connectors
212 - end walls / track sidewall end-guide surface
216 - separation distance between end guide surfaces
218 - end wall outer surface
220 - frame perimeter edge
222 - axle bearing holes
224 - fastener boss
226 - guide body (being the circuitous part)
228′, 228″, 228′″ - repeating switchback segments
230 - first guide chute
232 - first direction of rolling travel
234 - second guide chute
236 - second direction of rolling travel
238 - first arcuate chute deflector guide
240 - second arcuate chutedeflector
242 - first upper guide surface
244 - second upper guide surface
246 - guide surface separation distance
248 - cartridge exit guide
250 - cartridge exit chute (this is the support surface)
252 - cartridge exit guide rear wall
254 - cartridge exit arcuate deflector guide
256 - flanged catch ends
258 - cartridge heater
260 - resistive heating pad
262 - temperature sensor / thermocouple
264 - control connector
266 - controller
268 - circuit board 270, 272, 274, 276, 278, 280 -
electrical leads - wires / control and/or power lines

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A medical cartridge dispenser comprising:
a storage container structured to retain a plurality of medical cartridges in use;
a cartridge singulator; and
a user proximity sensor connected to trigger the cartridge singulator to dispense a medical cartridge from an outlet of the storage container.

2. The medical cartridge dispenser of claim 1 further comprising a cartridge heater.

3. The medical cartridge dispenser of claim 2 in which the cartridge heater is structured to maintain medical cartridges in the storage container at body temperature.

4. The medical cartridge dispenser of claim 2 in which the cartridge heater comprises a resistive heating pad.

5. The medical cartridge dispenser of claim 4 in which the resistive heating pad underlies, overlies, or defines at least part of a cartridge exit chute upstream of or at the outlet in the storage compartment.

6. The medical cartridge dispenser of claim 2 further comprising;
a temperature sensor; and
a temperature controller connected in a feedback loop to control an internal temperature of the storage compartment using the heater.

7. The medical cartridge dispenser of claim 1 in which the cartridge singulator comprises a rotatable cam.

8. The medical cartridge dispenser of claim 7 in which the rotatable cam defines a cartridge-advancing part and an upstream-cartridge-blocking part.

9. The medical cartridge dispenser of claim 8 in which the cartridge singulator comprises a dispensing drum that defines the rotatable cam.

10. The medical cartridge dispenser of claim 9 in which the dispensing drum defines the rotatable cam in an axial direction along a cylindrical sidewall of the dispensing drum.

11. The medical cartridge dispenser of claim 10 in which the rotatable cam is formed as an axial slot in the cylindrical sidewall, with the cartridge-advancing part defined by the axial slot, and the upstream-cartridge-blocking part defined by the cylindrical sidewall.

12. The medical cartridge dispenser of claim 11 in which the dispensing drum is structured to perform a single rotation to dispense a single cartridge in use.

13. The medical cartridge dispenser of claim 11 in which the outlet is defined on a cartridge exit chute, and the cartridge singulator is structured to roll individual cartridges along the cartridge exit chute and out the outlet.

14. The medical cartridge dispenser of claim 13 in which the dispensing drum is oriented such that a rotational axis of the dispensing drum is parallel with a rolling axis of a cartridge seated in the dispensing drum during use.

15. The medical cartridge dispenser of claim 7 in which the cartridge singulator comprises a motor and a timing cam.

16. The medical cartridge dispenser of claim 15 in which the timing cam is structured to engage a limit switch during each action of dispensing a medical cartridge by the singulator.

17. The medical cartridge dispenser of claim 1 in which the storage container defines an internal medical-cartridge-stacking track.

18. The medical cartridge dispenser of claim 17 in which the internal medical-cartridge-stacking track comprises a serpentine chute.

19. The medical cartridge dispenser of claim 1 further comprising a cartridge catch defined downstream of the outlet.

20. The medical cartridge dispenser of claim 19 in which the cartridge catch is formed of one or more cartridge stop walls that are adjacent a finger-receiving pincer zone.

21. The medical cartridge dispenser of claim 20 in which the user proximity sensor is configured to trigger the cartridge singulator upon detection of a user's hand above the cartridge catch.

22. The medical cartridge dispenser of claim 1 further comprising a plurality of carpules retained as medical cartridges within the storage container.

23. A method comprising initiating the user proximity sensor of the medical cartridge dispenser of claim 22 to trigger the cartridge singulator to dispense a medical cartridge from the outlet.

24. A method comprising:
sensing the presence of a user's hand in an activation zone adjacent a medical cartridge dispenser; and
triggering a cartridge singulator to advance a single medical cartridge, from a plurality of medical cartridges retained within a storage container, through an outlet.

25. The method of claim 24 further comprising pre-heating the plurality of medical cartridges within the medical cartridge dispenser.

26. The method of claim 24 in which triggering further comprises rotating a dispensing drum, of the cartridge singulator, to engage, within an axial slot defined along the dispensing drum, a cylindrical sidewall of the single medical cartridge, and advance the single medical cartridge through the outlet.
